(19) United States
(12) Patent Application Publication
(10) Pub. No.: US 2012/0224796 A1
(43) Pub. Date: Sep. 6, 2012

(54) FRICTION CONTROLLED DRAWER SLIDE MECHANISM

(75) Inventors: Mark R. Carey, JR., Upper Sandusky, OH (US); Gregory L. Williams, Columbus, OH (US); Matthew Allen McCarthy, Worthington, OH (US); Keith A. Overton, Columbus, OH (US)

(73) Assignee: CVG MANAGEMENT CORPORATION, New Albany, OH (US)

(21) Appl. No.: 13/372,886

(22) Filed: Feb. 14, 2012

Related U.S. Application Data
(63) Continuation of application No. 13/294,658, filed on Nov. 11, 2011.
(60) Provisional application No. 61/442,575, filed on Feb. 14, 2011.

(51) Int. Cl. A47B 88/16; B23P 11/00; F16C 29/02; A47B 88/04; B60N 2/075

(52) U.S. Cl. 384/21; 384/20; 384/34; 384/26; 29/428

(57) ABSTRACT

A friction controlled mechanism configured to operate in conjunction with an assembly having a moveable structure and a stationary structure. The mechanism includes a frame member having a length and a friction based flexible member slidably wrapped around a perimeter of the frame member such that the flexible member travels in opposite directions around the perimeter of the frame member during movement of the moveable structure toward and away from the stationary structure. The flexible member imparts a friction to side rails of the stationary structure and to side rails of the moveable structure to provide a controlled stable movement of the moveable structure.

### CROSS-REFERENCE TO RELATED APPLICATIONS

This application is a Continuation-in-Part of pending U.S. patent application Ser. No. 13/294,658 (Atty. Docket No. 104308.139US) entitled “FRICTION CONTROLLED DRAWER SLIDE MECHANISM” filed on Nov. 11, 2011 and claims the benefit of U.S. Provisional Patent application Ser. No. 61/442,575 entitled “CRAWLER TRACK DRAWER SLIDE AND APPLICATIONS THEREOF” filed on Feb. 14, 2011.

### ORIGIN

The innovation disclosed herein relates to cabinet design and more specifically to a friction controlled mechanism such as a slide assembly to provide a stable movement of a moveable structure such as a drawer in a cabinet.

### BACKGROUND

In the field of cabinet design, and more particularly to slide assemblies or drawer guides, conventional slide assemblies utilize heavy steel roller designs, which have limitations and are expensive. Thus, conventional steel roller designs not only increase cost but also add unnecessary weight to the cabinet. In addition, conventional steel drawers with steel sliders typically have a catch because they do not integrate any translation movement. The conventional steel units simply rely on the fact that if they travel the full extension before they begin to bring the rolling member out they are strong enough all the way through that motion until such time as they engage the second slider. Thus, conventional steel sliders are overdesigned by purpose to work on the cantilever forces imparted.

In addition, in transportation vehicle-based cabinet product lines, conventional steel roller bearing designs employ a near zero friction roller bearing design. This allows the drawer to inadvertently open due to the shifting of inertia in the drawer caused by the movement of the vehicle.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof includes a friction controlled mechanism configured to operate in conjunction with an assembly having a moveable structure and a stationary structure. The mechanism includes a frame member having a length and a friction based flexible member slidably wrapped around a perimeter of the frame member such that the flexible member travels in opposite directions around the perimeter of the frame member during movement of the moveable structure toward and away from the stationary structure. The flexible member imparts a friction to side rails of the stationary structure and to side rails of the moveable structure to provide a controlled stable movement of the moveable structure.

In accordance with another aspect of the innovation, the flexible member has frictional properties that facilitate a controlled stable movement of the moveable structure when a minimal force is applied to the moveable structure while simultaneously preventing the moveable structure from moving when a force exerted on the moveable structure is less than the minimal force.

In accordance with yet another aspect of the innovation, a method of assembling a friction controlled mechanism for use in a vehicle is provided. The method includes providing a frame member, providing a flexible member, wrapping the flexible member around a perimeter of the frame member such that the flexible member is free to travel around the perimeter of the frame member in opposite directions, and attaching a stop to the frame member.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1A illustrates a left side perspective view of a drawer assembly incorporating a friction controlled mechanism in accordance with aspects of the innovation.

FIG. 1B illustrates a right side perspective view of a drawer assembly incorporating the friction controlled mechanism in accordance with aspects of the innovation.

FIG. 2 illustrates a cross-sectional view of the friction controlled mechanism of FIGS. 1A and 1B in accordance with aspects of the innovation.

FIG. 3 illustrates a perspective view of the friction controlled mechanism in accordance with aspects of the innovation.

FIG. 4 illustrates a disassembled perspective view of the drawer assembly of FIGS. 1A and 1B in accordance with aspects of the innovation.

FIG. 5 illustrates a disassembled perspective view of the friction controlled mechanism in accordance with aspects of the innovation.

FIG. 6 illustrates a modified embodiment of the friction controlled mechanism in accordance with aspects of the innovation.

FIG. 7 illustrates an example method of assembling the friction controlled mechanism of FIGS. 1A and 1B in accordance with aspects of the innovation.

FIG. 8 illustrates an alternate embodiment that connects more than one friction controlled mechanisms with an axel or shaft in accordance with aspects of the innovation.

FIG. 9 is a perspective view illustrating an alternate example embodiment of a drawer assembly incorporating an alternate embodiment of the friction controlled mechanism having a curved or arched configuration in accordance with aspects of the innovation.

FIG. 10 is a perspective view illustrating an example embodiment of a glove box assembly incorporating an alternate embodiment of the friction controlled mechanism in accordance with aspects of the innovation.

FIG. 11 is a perspective view illustrating an alternate example embodiment of a dashboard assembly incorporating the friction controlled mechanism in accordance with aspects of the innovation.

FIG. 12 is a perspective view illustrating an example embodiment of a seat assembly incorporating the friction controlled mechanism in accordance with aspects of the innovation.

FIG. 13 is a perspective view illustrating an alternate example embodiment of a seat assembly incorporating the friction controlled mechanism in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

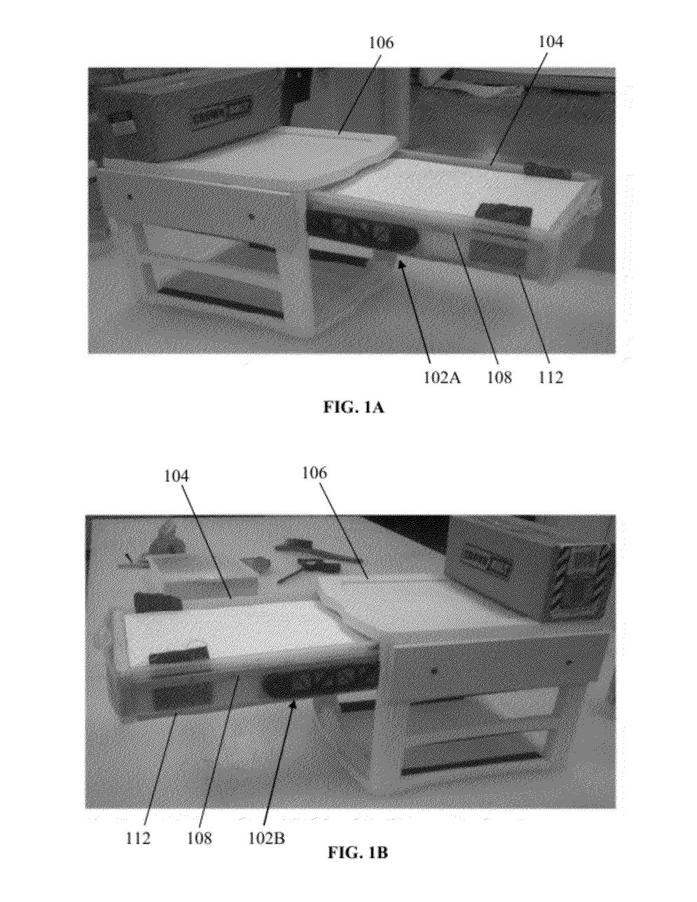

Referring now to the drawings, FIGS. 1A and 1B are left and right perspective views respectively of a cabinet assembly system 100 incorporating a friction controlled mechanism 102, such as but not limited to an example drawer slide assembly 102A, 102B (collectively “slide assembly 102”) in accordance with aspects of the innovation. It is to be appreciated that while the example embodiment of the innovation described herein and shown in the figures is in association with a drawer assembly type cabinet, the features, functions and benefits of the innovation can be applied to countless other uses and applications. Some uses and applications within the scope of the innovation include, but not limited to, transportation vehicle-based cabinet product lines for drawers and moving work surfaces, consumer home cabinetry industry (e.g., kitchen and bathroom cabinets), consumer and industrial cabinetry industry (e.g., tool cabinets, platforms, bins, etc.), consumer and industrial moveable work surfaces, doors, etc., and the automotive moving storage market, such as, a bin/drawer/cup holder/etc. Essentially, most any consumer and industrial market that employs controlled cantilevered movement between two members (e.g., vertical lifts, horizontal beam devices, moving trays) can benefit from the innovation described herein. Similarly, general purpose or specialized applications of the cabinetry (or other) industry can employ the features, functions and benefits of the innovation. Thus, the embodiment described herein and shown in the figures, along with the above applications, are for illustrative purposes only, and are not intended to limit the scope of the innovation.

Referring again to FIGS. 1A, 1B, and 2-5, in one example embodiment, the cabinet assembly 100 includes a moveable structure 104 and a stationary structure 106. The moveable structure 104 can be any moveable structure including, but not limited to, a drawer, an extendable platform (work surface), a door, etc. The stationary structure 106 may be any stable structure including, but not limited, a cabinet, a wall, door frame, etc. The term “stationary” does not exclusively refer to a rigid non-moveable structure. “Stationary,” as used herein, refers to a stable structure that remains stationary when the moveable structure 104 is operated. In some applications, the stationary structure 106 can itself be moveable, such as a consumer dresser, a mobile tool chest or the like. In addition, in some aspects, one or both of the moveable structure 104 and the stationary structure 106 can be made from plastic, wood, metal, composite, alloy, or the like. Reaction Injection Molding (RIM) or other injection molding techniques can be employed to manufacture the structures 104, 106.

The moveable structure 104 includes a moveable upper side rail 108 having a first moveable surface 110 and a moveable lower side rail 112 having a second moveable surface 114 located on each outer side 116 of the moveable structure 104. The upper and lower moveable side rails 108, 112 are substantially parallel to each other.

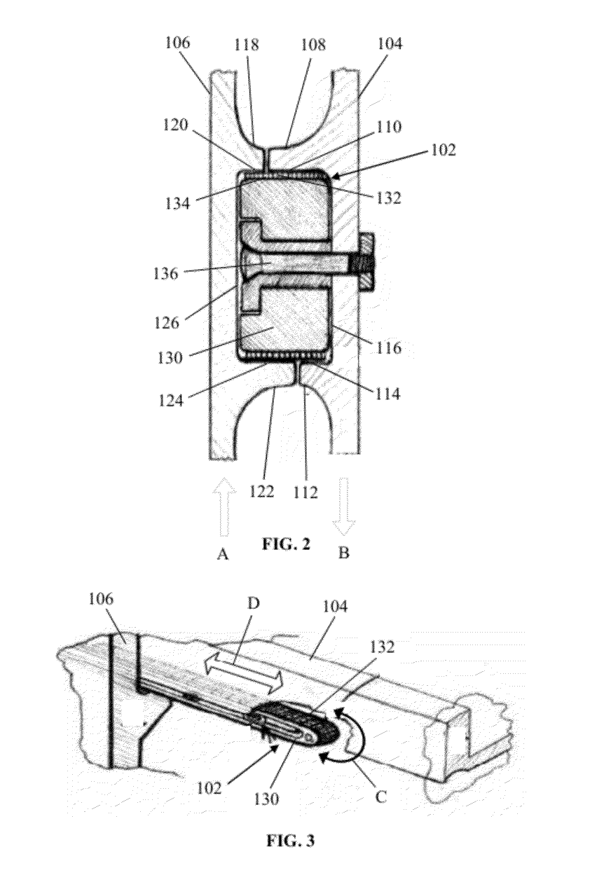

The stationary structure 106 includes a stationary upper side rail 118 having a first stationary surface 120 and a stationary lower side rail 122 having a second stationary surface 124 (best shown in FIG. 2) attached on each inner side 126 of the stationary structure 106. The upper and lower stationary side rails 118, 122 are substantially parallel to each other. The moveable upper and lower side rails 108, 112 and the stationary upper and lower side rails 118, 122 cooperate with the slide assembly 102 to facilitate a sliding motion of the moveable structure 104 within an opening 128 of the stationary structure 106. Thus, the moveable structure 104 is slidably moveable within the opening 128 of the stationary structure 106.

The slide assembly 102 includes a frame member 130 and a flexible member 132, shown unassembled in FIG. 5. The flexible member 132 is slidably attached (FIGS. 1A, 1B, and 2-4) around a perimeter 134 (see also FIG. 5) of the frame member 130. The flexible member 132 is not fixedly attached to the frame member 130 such that the flexible member 132 cannot move. Rather, during operation of the moveable structure 104, the flexible member 132 travels around the perimeter 134 of the frame member 130 while simultaneously being constrained to remain on a surface of the perimeter 134 of the frame member 130.

The frame member 130 can be made from a flexible material to allow the frame member 130 to configure to a contour generated by the moveable upper and lower rail 108, 112. On the other hand, the flexible member 132 can be more rigid and have a more permanent shape. Thus, the flexible member 132 can be made from any suitable material such as but not limited to plastic, wood, metal, composite, alloy, or the like.

The flexible member 132 has frictional properties that facilitate a controlled-stable sliding motion of the moveable structure 104 into and out of the stationary structure 106 with minimal force. On the other hand, the flexible member 132 has frictional properties that prevent the moveable structure 104 from inadvertently moving into and out of the stationary structure 106 when a force applied to the moveable structure 104 is less than the minimal force. Such a force may be due to inertia caused by, for example, the movement of a vehicle in the case of transportation vehicle-based cabinet product lines. Thus, the flexible material can be any material capable of providing a controlled friction movement having the frictional properties mentioned above, such as but not limited to, a hook material, a loop material or a combination thereof, a web type material, roller chain, etc. It is to be appreciated that the use of hook and hook/loop materials employ tolerance absorbing characteristics that can be used in applications different from those described herein. These alternative materials and applications are to be included within the scope of the specification and claims appended hereto.

Referring to FIGS. 2-4, the slide assembly 102 is attached to each outer side 112 of the moveable structure 104 between the moveable upper side rail 108 and the moveable lower side rail 110. The slide assembly 102 can be attached by either simply sandwiching the slide assembly 102 between the moveable upper and lower rails 108, 112 or it can be attached to the outer side 112 with one or more optional fastener elements 136, such as but not limited to a screw, a rivet, etc. The fastener elements 136 are configured to absorb side, vertical, and tensile loads.

When attached to the moveable structure 104, the flexible member 132 is in contact with the first moveable surface 110 of the moveable upper side rail 108 and the second moveable surface 114 of the moveable lower side rail 112. Further, when attached, the slide assembly 102 is situated such that a front 138 of the slide assembly 102 is disposed approximately halfway between a front 140 and a rear 142 of the moveable structure 104. Thus, approximately half of the slide assembly 102 extends beyond the rear 142 of the moveable structure 104. As a result, when the moveable structure 104 is in a fully extended or open position, as shown in FIGS. 1A and 1B, no more than approximately half of the slide assembly 102 extends beyond a front 144 of the stationary structure 106. This arrangement provides maximum cantilevered support thereby minimizing a downward tilting of the moveable structure 104 when in the fully extended or open position. Other advantages regarding the arrangement are discussed further below.

Referring back to FIGS. 1A, 1B, and 2, when the moveable structure 104 is inserted into the opening 128 of the stationary structure 108, the flexible member 132 is in contact with the first stationary surface 120 of the stationary upper side rail 118 and the second stationary surface 124 of the stationary lower side rail 122. Thus, as best shown in FIG. 2, the slide assembly 102 is “sandwiched” in a horizontal direction between the outer side 116 of the moveable structure 104 and the inner side 126 of the stationary structure 106 and in a vertical direction between the first moveable surface 110 and the second moveable surface 114, and the first stationary surface 120 and the second stationary surface 124.

This arrangement helps distribute loads between the moveable structure 104 and the stationary structure 106. Specifically, as shown in FIG. 2, arrow “A” indicates a direction of a major load resistance force upon the stationary structure 106. Similarly, arrow “B” indicates a direction of a major load resistance force upon the moveable structure 104. The arrangement of the slide assembly 102 distributes the loading action between the moveable structure 104 and stationary structure 106 to thereby minimize loads and stresses between moveable structure 104 and stationary structure 106.

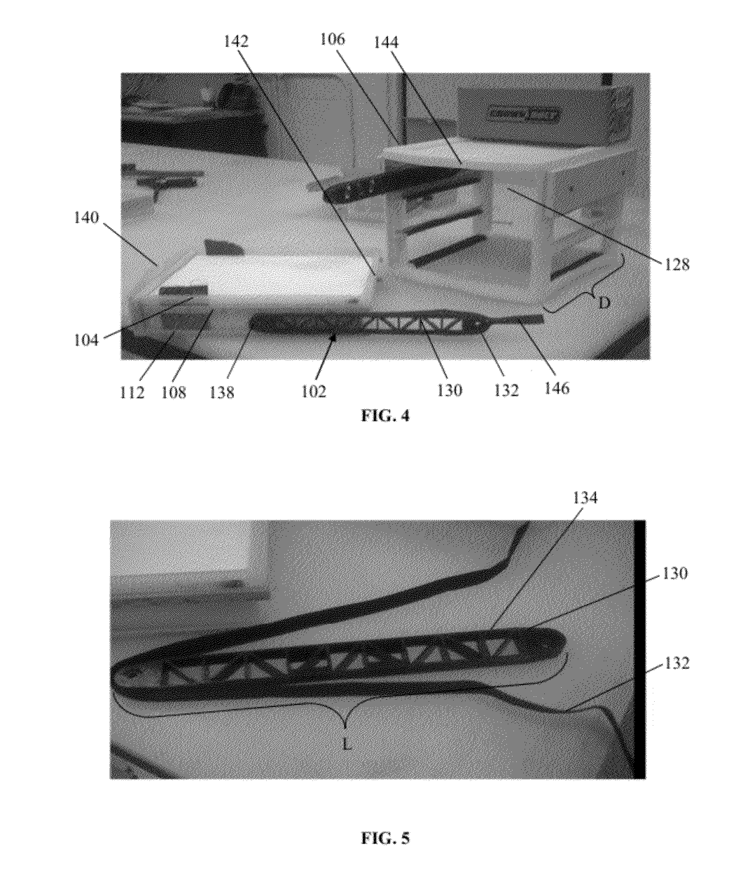

The slide assembly 102 further includes a stop 146 that prevents over extension of the moveable structure 104 from the stationary structure 106 (see FIG. 4). In the embodiment shown in FIG. 4, the stop 146 is a strap that attaches to a rear of the slide assembly 102 and to a rear portion of the stationary structure 106, once the moveable structure 104 is inserted into the opening 128 of the stationary structure 106. It is to be appreciated, however, that the stop 146 and functionality thereof can be comprised of pins, a catch, bracket, or any other type of stop without departing from the scope of the innovation.

During operation of the moveable structure 104 into and out of the stationary structure 106, the flexible member 132, due to a pressure from each moveable side rail 108, 112 and each stationary side rail 118, 122, imparts a friction to each of the first moveable surface 110, second moveable surface 114, first stationary surface 120, and second stationary surface 124. The friction causes the flexible member 132 to travel around the frame member 130 in the direction of the double sided arrow “C” depending on the direction of the moveable structure 104 indicated by the double sided arrow “D.” Thus, the flexible member 132 can travel in opposite directions around the perimeter 134 of the frame member 130. The stop 146 limits the travel of the moveable structure 104 out of the opening 128 of the stationary structure 106.

The example slide assembly 102 described above coupled with the friction properties of the flexible member 132 provides a controlled-stable movement of the moveable structure 104 into and out of the stationary structure 106. Further, the slide assembly 102 provides a load/force bearing to the stationary structure 106. Still further, the slide assembly 102 provides positive vertical and supplementary horizontal and translational force/load control. As mentioned above, the slide assembly 102 also provides maximum cantilevered support thereby minimizing a downward tilting of the moveable structure 104 with respect to the stationary structure 106 when in the fully extended or open position. Still yet another advantage to the innovation is that the slide assembly 102 provides a “distributed” loading of the action between the moveable structure 104 and the stationary structure 106 attached in a “cantilevered” configuration.

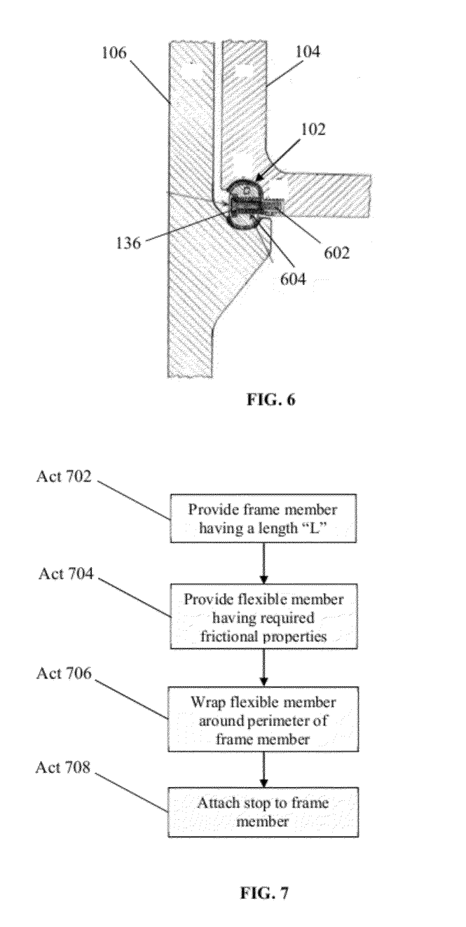

In an alternative example embodiment shown in FIG. 6, a load distribution fastener attachment element 602 can be used to transfer with distribution the load between the fastener element 136 and the moveable structure 104. In addition, a rolling bearing element 604 can be used to provide an “anti-friction” roller action between the fastener element 136 and the slide assembly 102.

Referring to FIG. 7, a method of assembling the above described slide assembly 102 with reference to FIGS. 4 and 5 is disclosed. At Act 702, a frame member 130 is provided. The frame member 130 has a length “L” that is less than a depth “D” of the stationary structure 106. As mentioned above, the frame member 130 can be flexible or rigid and can be made from any suitable material, such as but not limited to, plastic, wood, metal, composite, alloy, or the like. At Act 704, the flexible member 132 is provided that has the frictional properties described above. At Act 706, the flexible member 132 is wrapped around the perimeter 134 of the frame member 130 such that the flexible member 132 is free to travel around the perimeter 134 of the frame member 130. At Act 708, the stop 146 is applied to the frame member 130 in the form of a strap, pin, catch, etc. The slide assembly 102 is then attached to the moveable structure 104 and implemented as described above.

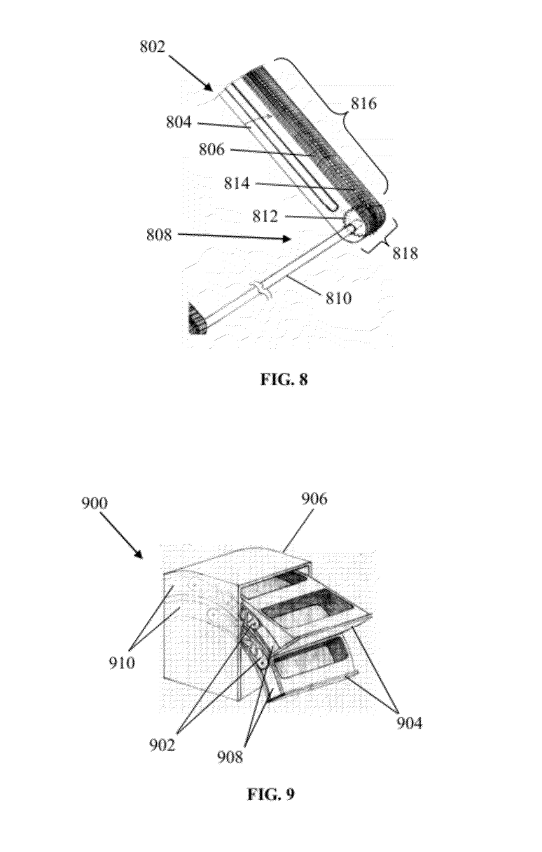

In still yet another example embodiment shown in FIG. 8, one or more substantially parallel slide assemblies 802 having a frame member 804 and a flexible member 806 can be operated via a drive mechanism 808. The drive mechanism 808 includes an axel 810, a gear 812 attached to each end of the axel 810, and a chain 814. The drive mechanism 808 provides synchronized movement, braking, and centering of the flexible member 806 for each slide assembly 802. In addition, a curved surface 816 of the frame member 804 beneath the flexible member 806 acts against the chain 814. The curved surface 816 provides a lateral force resistance against the flexible member 806 to keep the flexible member 806 centered. A flat surface 818 of the frame member 804 assists to change the direction and align the flexible member 806. It is to be appreciated that while the example drive mechanism shown in FIG. 8 includes an axel, gears and chain, other similar functioning drive mechanisms are that enable synchronization of the slide mechanisms are to be included within the scope of the innovation and claims appended hereto.

FIG. 9 is a perspective view of an alternate cabinet assembly 900 incorporating another example embodiment of a friction controlled mechanism 902. The cabinet assembly 900 is similar to the embodiment described above in that it includes one or more moveable structures 904 and a stationary structure 906 and employs the aforementioned features, functions and benefits of the innovation above. The main difference between the embodiment described above and the embodiment shown in FIG. 9 is that the one or more moveable structures 904 move in a curved or arched motion. Thus, the friction controlled mechanism 902 is curved or arched to conform to curved or arched channels 908, 910 of the one or more moveable structures 904 and the stationary structure 906. The friction controlled mechanism 902 can be either flexible in that it conforms itself to the contour of the curved or arched channel 908, 910 of the one or more moveable structures 904 and the stationary structure 906 respectively or it can be more rigid and have a more permanent curved or arched shape.

The embodiment shown in FIG. 9 can be especially useful for overhead or raised height designed drawer assemblies. For example, a user can reach to pull down the drawer which is frictionally controlled the friction controlled mechanism 902. Thus, items within the moveable structure 904 can be presented in a vertical or near vertical orientation thereby enabling a user to reach and/or view the items. Latches, catches, locks, etc. are contemplated and can be employed when and where appropriate or desired. It is to be appreciated that the one or more moveable structures 904 can be connected by a common axel and driven simultaneously with a drive mechanism similar to the one described above.

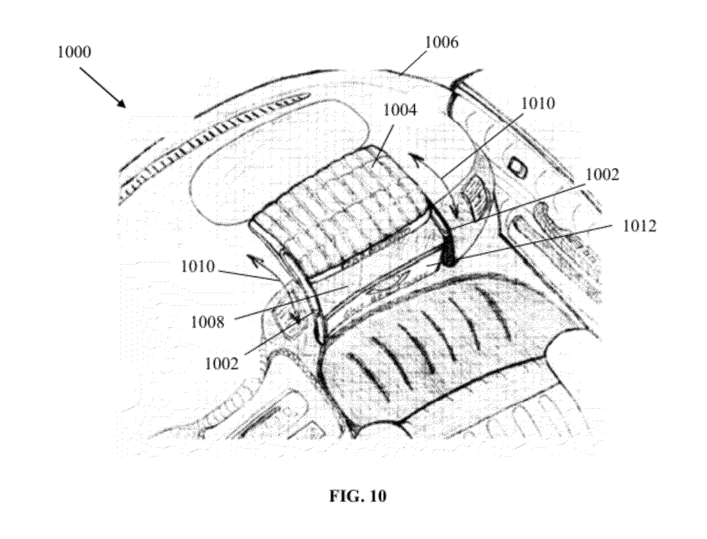

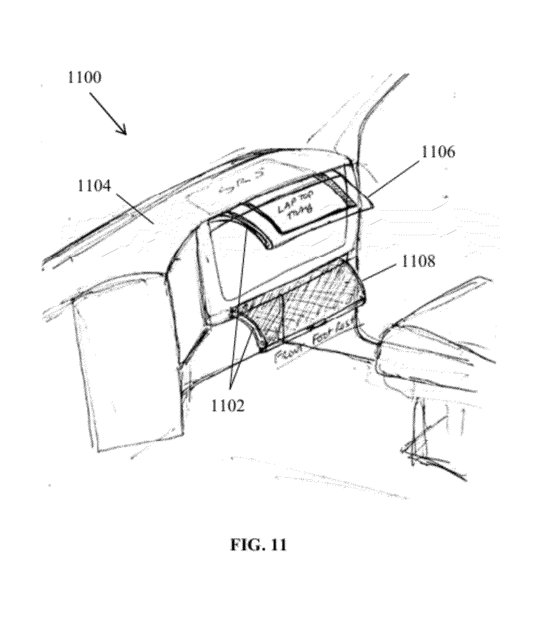

FIG. 10 is a perspective view of another example assembly 1000 incorporating another example embodiment of a friction controlled mechanism 1002. Specifically, the assembly is a glove box assembly 1000 that includes a slidable door (moveable structure) 1004 mounted in a vehicle dashboard or instrument panel (stationary structure) 1006, and a cavity (compartment) 1008 defined in the dashboard 1006. The door 1004 moves in a curved or arched motion as indicated by the double sided arrow 1010. Thus, the friction controlled mechanism 1002 is curved or arched to conform to curved or arched channels of the door 1004 and the dashboard 1006. The friction controlled mechanism 1002 can be either flexible in that it conforms itself to the contour of the curved or arched channels or it can be more rigid and have a more permanent curved or arched shape.

Still referring to FIG. 10, the door 1004 is slidable in a curved upward (or open) direction to expose the compartment 1008 and in a downward (or closed) direction to conceal the compartment 1008. It is to be appreciated, however, that the door 1004 can also be slidable in a downward direction to expose the compartment 1008 and slidable in an upward direction to conceal the compartment 1008. It is to be further appreciated that the door 1004 can slide either upwards or downwards to expose the compartment 1008 and be disposed approximately halfway between the upwards and downwards positions to conceal the compartment 1008. The curved motion of the door 1004 is such that when the door 1004 moves from the closed position to the open position the door 1004 follows the curvature of the dashboard 1008. Thus, when the door 1004 is in the open position, the door 1004 is substantially parallel to a top of the dashboard 1008. This arrangement lends itself to additional features of the glove box assembly 1000, as will be subsequently described.

Specifically, one additional feature of the glove box assembly 1000 is that the door 1004, when in the upward or open position, may also double as an upper foot rest. Alternatively, in yet another example embodiment, the door 1004 can slide in a downward direction, which would not only expose the compartment 1008, but also serve as a lower foot rest. In these embodiments, the door 1004 can be covered with a rigid or wear resistant material so as to enhance the durability of the door 1004 when used as an upper or lower foot rest. For example, some example materials may include rubber, plastic, metal, etc. In addition, a pattern can be molded into the material or onto a surface of the door 1004.

Another feature of the glove box assembly 1000 is that the door 1004, when in the open position, may serve as a table or tray. The tray could be used for any practical purpose, such as but not limited to, a beverage and food tray, a laptop tray, a writing surface, etc.

In an alternate embodiment, a slidable drawer (a second moveable structure) 1012 may be included inside the compartment 1008. The slidable drawer 1012 may also incorporate the friction controlled mechanism 1002 described above and, thus operate in a manner similar to the embodiments described above.

Thus, in summary, the embodiment described above and illustrated in FIG. 10 is a multi-position assembly that serves to remain stationary in the down (closed) position, remain stationary in the upward (open) position, remain stationary in the upward position to serve as a foot rest, a tray, a writing surface, etc. Further, the assembly 1000 may include an optional drawer 1012 that allows easier access and additional organized storage versus conventional glove box assemblies.

In addition, it is to be understood that the innovation can be integrated into, or communicate with, passenger safety systems so that indications that the door 1004 is in the upward or open position trigger the necessary safety system changes. For example, when in the open position, the innovation can automatically trigger or, if appropriate, disengage air-bag protection devices, belts or any other safety mechanism. These and other aspects will be understood by those skilled in the art and are to be considered part of the innovation and claims appended hereto. For example, pressure and/or proximity sensors can be used as appropriate to engage and/or disengage safety mechanisms.

FIG. 11 is a perspective view of another example assembly 1100 incorporating another example embodiment of a friction controlled mechanism 1102. Specifically, the assembly is similar to that of a dashboard or instrument panel 1104 in a vehicle that includes a slidable tray (moveable structure) 1106 and a slidable foot rest (second moveable structure) 1108. Either one or both of the slidable tray 1106 and the slidable foot rest 1108 may incorporate the friction controlled mechanism 1102 described above. The slidable tray 1106 may be used for any practical purpose, such as but not limited to, a beverage and food tray, a laptop tray, a writing surface, etc. Both the slidable tray 1106 and the slidable foot rest 1108 slide into and out of the dashboard 1104 to accommodate a person seated in for example a passenger seat of a vehicle, such as but not limited a long haul cab.

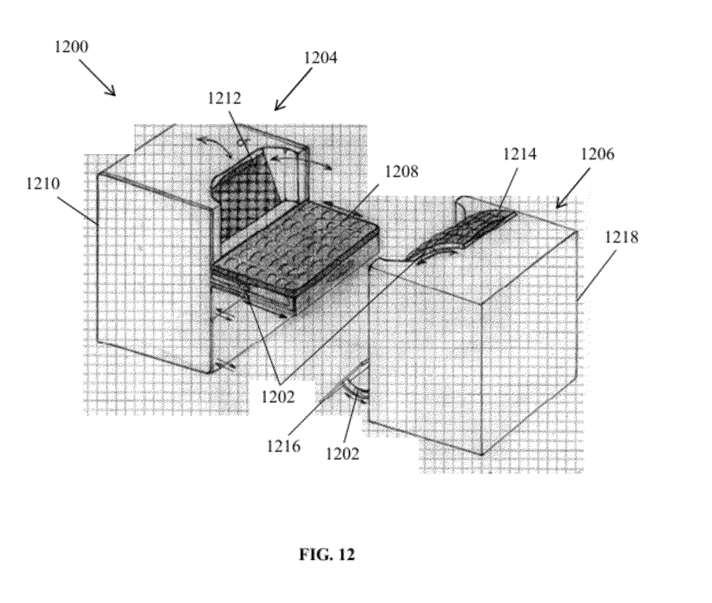

FIG. 12 is a perspective view of another example assembly 1200 incorporating another example embodiment of a friction controlled mechanism 1202. Specifically, the assembly is a seating apparatus 1200 that includes a seat assembly 1204 and a foot rest assembly 1206.

The seat assembly 1204 includes a slidable seat (moveable structure) 1208 and a cabinet (stationary structure) 1210. An adjustable back and neck rest (second moveable structure) 1212 may be incorporated into the cabinet 1210, as illustrated. The friction controlled mechanism 1202 operates similar to the example embodiment described above. In this embodiment, however, the friction controlled mechanism 1202 can be configured to compensate from most any force experienced in a seating or other design aspect. For example, the friction controlled mechanism 1202 can be manufactured to withstand approximately 1,000 pounds of dynamic force, such as that associated with a person sitting or stepping on the seat 1208. Thus, when a heavy load is applied to the seat 1208, it will be understood that the friction controlled mechanism 1202 locks into place and does not permit further transition. Further, floor brackets may be incorporated to attach the cabinet 1210 to a more rigid structure, such as the floor or wall.

The foot rest assembly 1206 includes a slidable upper door (third moveable structure) 1214, a slidable lower door (fourth moveable structure) 1216, and a cabinet (stationary structure) 1218. Both the upper and lower doors 1214, 1216 incorporate the friction controlled mechanism 1202 described above. The upper door 1214, when in the open position, may expose a compartment located in an upper portion of the cabinet 1218 for storage purposes. Further, the upper door 1214, when in the open position, may serve as an upper foot rest for a person seated in the seat assembly 1204 described above. The lower door 1216, when in the open position may expose a second compartment located in a lower portion of the cabinet 1218. Further, the lower door 1216, when in the open position, may serve as a lower foot rest for a person seated in the seat assembly 1204 described above.

In the embodiment illustrated in FIG. 12, the example seating apparatus 1200 can be useful in locations with space restrictions (e.g. long haul truck cabs). Thus, the innovation can employ facing cabinets to form a seated area with an accompanying foot support, whereby both the seated assembly and the foot support incorporate storage capabilities.

Still referring to FIG. 12, it is to be appreciated that seat assembly 1204 can be used for other applications, such as but not limited to, a step to reach to reach an elevated space, such as an upper cabinet or a bunk bed in a cab of a long haul truck. In addition, a non-slip surface can be incorporated onto a surface of the slidable seat 1208 to prevent accidental slipping.

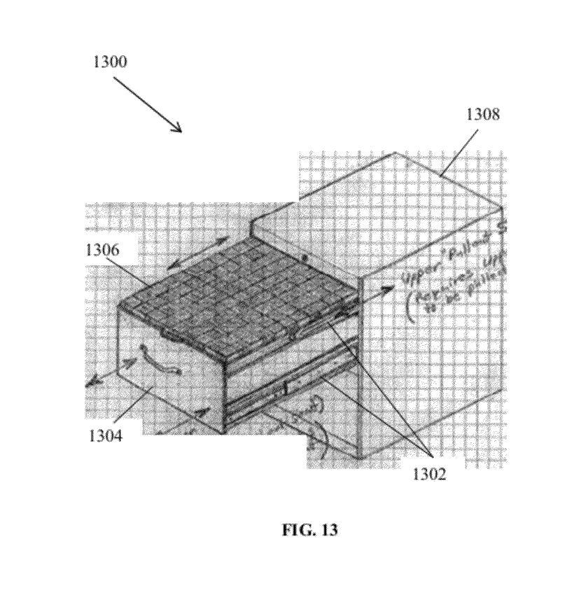

FIG. 13 is a perspective view of another example assembly 1300 incorporating another example embodiment of a friction controlled mechanism 1302. Specifically, the assembly is a seating/storage assembly 1300 that includes a slidable drawer (moveable structure) 1304 disposed below a slidable seat (second moveable structure) 1306, and a cabinet (stationary structure) 1308. Either one or both of the slidable drawer 1304 and the slidable seat 1306 may incorporate the friction controlled mechanism 1302 described above. It is to be understood that the drawer 1304 and the seat 1306 can slide independent of each other. However, the design may be configured to restrict opening of the seat 1306 separate from the drawer 1304 to prevent injury or damage. The seat 1306 can be manufactured from a flexible rigid material that is capable of absorbing deflections in the seat without causing any harm or damage to the drawer's contents. This embodiment is useful in areas with space restrictions and can also be incorporated as an add-on to exiting cabinets.

As the above embodiments illustrate, the shape, size and/or configuration of the moveable and stationary structures and friction controlled mechanism can vary without departing from the features, functions and benefits of the innovation. These variations are to be included within the scope of this disclosure and claims appended hereto. For example, the innovation described herein can be used in a two-way moveable structure application. For example, an extendable platform (work surface) and/or drawer can move in two directions to opposite sides of a cabinet or a kitchen island. Thus, the moveable structure could be a double sided drawer where the user could access the drawer from opposite sides of the cabinet or island. Whereas, conventional steel sliders include stops that prevent two way directional operation.

In other aspects, the innovation can be employed on moveable structures having a curved (or arched) motion. For example, in this aspect, drawers can be placed or positioned above a user's height whereby, when opened, the drawers move in a downward curved direction for easy accessibility. It will be appreciated that some aspects can employ a latch, catch, lock or other preventative opening system as desired. It should be noted that in some aspects, the movement of the moveable structure can be in an upward direction.

Another aspect can employ dual movement/telescopic moveable structures such as but not limited to work surfaces.

The depth of moveable structures can vary, thus, the innovation is not limited to the size of the moveable structure.

Still other aspects can employ one or more slide assemblies driven with a drive mechanism. The drive mechanism can include an axel, gear, and chain configuration, which can be adapted to include a motor to drive the moveable structure. This mechanically or electrically powered motion can assist, for example, with heavy loads and effect remote power to place items in an accessible position or reach of a user.

In yet other aspects, the innovation can be employed as a center-less hinge pivot that is capable of having an off-set mounting surface with a common aligned rotational axis point. In application, the zero point or the axle point of the hinge is in space as open space. Thus, if the innovation is used as a hinge for a door and the door translates and rotates at the same time, one can design a hinge point for a curved door that has no traditionally conceivable mounting surfaces in common in plane. Normally, this would mean that one would have a door that would pivot up at an angle or down at an angle. Alternatively, spacers would have to be used on the door to keep it all on the same hinge plane which makes for extra weight, extra load, and extra cantilevering forces. However, using various upper, mid or lower circular arch dimensions, the innovation can align “non-planer” mounting surfaces to act on a common “in-space” axis point using the center-less device.

Thus, in accordance with the innovation, one can put direct forces on the door at the door hinge off of the inside, one at the top, one at the bottom and even one in the middle. All three of the slide assemblies can be on different mounting points prescribed around the same hinge point, e.g., desirable tilt, non-desirable tilt, flat, etc. This can be accomplished in space simply by changing the arc radius on each of the other hinges. It would not matter if the door was curved or unconventionally (non-planer) shaped. Rather, the mounting surfaces could be as variable as desired.

While many of the aspects described herein refer to a horizontal orientation, it is to be understood that other aspects can employ the slide assembly in a vertically mounted arrangement with a slide assembly at the top and a slide assembly at the bottom. Here, if the slide assemblies are equipped with a gear(s) having an axle in the back, racking can be alleviated and/or eliminated. Thus, even though there is a cantilever load in the worst possible condition, the fact that the slide assemblies are tied together means that the top will not allow the bottom to rack more than the tolerance that is built into the system. Essentially, the slide assemblies not only can be used in a horizontal mode, but can also be used in a vertical mode.

In all, it is to be appreciated that the slide assembly can employ a flexible member made of most anything that actually allows for bearing the friction that is intended to be beared, translating a member that is intended to be translated and moving in a back and forth motion in a smooth, normal fashion while maximizing load distribution (e.g., utilizing half in, half out slide assembly design).

It is to be appreciated that aspects of the innovation can employ a dampener, a spring loaded device or a power device that can assist in motion and/or counter force as required or desired.

In addition, conventional steel drawers with steel sliders typically have a catch because they do not integrate any translation movement. The traditional steel units simply rely on the fact that if they travel the full extension before they begin to bring the rolling member out they are strong enough all the way through that motion until such time as they starting bringing the second member of the slider out. Thus, traditional steel sliders are overdesigned by purpose to work on the cantilever forces imparted. In contrast, the innovation described herein offers more robustness. Specifically, the innovation discloses a notion of applying a translation motion while bearing on an integral system for load distribution of an overhanging cantilever device. In operation, the slide assembly can retain aligned position, half in and half out, relative to the maximum utility of the design of some sliders, some conventional sliders interface on both ends of the cantilever.

It will be appreciated that the innovative slide assembly can control friction by design. This is particularly useful in transportation (e.g., long-haul truck) applications. For example, by design, friction can be controlled such that it can be essentially constant regardless of weight or contents of a drawer. Another benefit of a controlled friction mechanism is preventing the inadvertent opening of a drawer in a moving truck due to inertia caused by the moving truck. Conventional roller bearing designs employ a near zero friction roller bearing design, which allows the drawer to inadvertently open due to the shifting of inertia in the drawer caused by the movement of the truck. The controlled friction of the innovation alleviates this condition.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A friction controlled mechanism configured to operate in conjunction with an assembly having a moveable structure and a stationary structure comprising:
a frame member having a length; and
a friction based flexible member slidably wrapped around a perimeter of the frame member such that the flexible member travels in opposite directions around the perimeter of the frame member during movement of the moveable structure toward and away from the stationary structure,
wherein the flexible member imparts a friction to side rails of the stationary structure and to side rails of the moveable structure to provide a controlled stable movement of the moveable structure.

2. The friction controlled mechanism of claim 1, wherein the flexible member has frictional properties that facilitate a controlled stable movement of the moveable structure when a minimal force is applied to the moveable structure while simultaneously preventing the moveable structure from moving when a force exerted on the moveable structure is less than the minimal force.

3. The friction controlled mechanism of claim 2, wherein the flexible member is made from one of a hook material, a loop material, hook/loop material, a web type material, a chain or the like.

4. The friction controlled mechanism of claim 3, wherein the friction controlled mechanism further includes a stop to limit the travel of the moveable structure away from the stationary structure.

5. The friction controlled mechanism of claim 2, wherein the moveable structure is a slidable door moveable in an upward and downward curved motion, wherein when the slidable door is in an upward position, the cavity is exposed and the slidable door serves as an upper foot rest and when the slidable door is in the downward position, the cavity is exposed and the slidable door serves as a lower foot rest and when the slidable door is approximately halfway between the upward and downward position, the slidable door conceals a cavity defined in the stationary structure.

6. The friction controlled mechanism of claim 5, wherein the slidable door includes a curved channel on each outer side and the stationary structure includes a curved channel on each inner side, and wherein the friction controlled mechanism conforms to the configuration of the curved channels of the slidable door and the stationary structure.

7. The friction controlled mechanism of claim 6, wherein the assembly is a glove box assembly for a vehicle and the stationary structure is a dashboard.

8. The friction controlled mechanism of claim 7, wherein the glove box assembly further includes a second moveable structure comprised of a slidable drawer located inside the cavity and incorporating the friction controlled mechanism.

9. The friction controlled mechanism of claim 2, wherein the assembly is a dashboard assembly for a vehicle and the moveable structure is a slidable tray and the stationary structure is a dashboard, wherein the slidable tray serves as a surface for use by a passenger of the vehicle.

10. The friction controlled mechanism of claim 9, wherein the dashboard assembly includes a second moveable structure incorporating the friction controlled mechanism, the second moveable structure comprising a foot rest.

11. The friction controlled mechanism of claim 2, wherein the assembly is a seating apparatus that includes a seat assembly, wherein the moveable structure is a slidable seat and the stationary structure is a cabinet, and wherein when a load is applied to the slidable seat, the friction controlled mechanism locks the slidable seat and prevents the slidable seat from moving.

12. The friction controlled mechanism of claim 11, wherein the seat assembly further includes a second moveable structure, the second moveable structure comprised of an adjustable back and neck rest.

13. The friction controlled mechanism of claim 12, wherein the seating apparatus further includes a foot rest assembly having a third moveable structure and a second stationary structure, the moveable structure comprised of a slidable upper door, wherein when the slidable upper door is in an open position, the slidable upper door serves as an upper foot rest and exposes a first storage compartment in an upper portion of the stationary structure.

14. The friction controlled mechanism of claim 13, wherein the foot rest assembly includes a fourth moveable structure comprised of a slidable lower door, wherein when the slidable lower door is in an open position, the slidable lower door serves as a lower foot rest and exposes a second storage compartment in a lower portion of the stationary structure.

15. The friction controlled mechanism of claim 2, wherein the assembly is a seating storage assembly comprised of a first moveable structure and a second moveable structure, wherein the first moveable structure and the second moveable structure move independently from each other.

16. The friction controlled mechanism of claim 15, wherein the first moveable structure is a slidable storage drawer and the second moveable structure is a slidable seat, wherein the seat is disposed above the slidable storage drawer and the slidable storage drawer restricts the open motion of the slidable seat.

17. A friction controlled mechanism configured to operate in conjunction with an assembly having a moveable structure and a stationary structure comprising:
a frame member having a length; and
a friction based flexible member slidably wrapped around a perimeter of the frame member such that the flexible member travels in opposite directions around the perimeter of the frame member during movement of the moveable structure toward and away from the stationary structure,
wherein the flexible member has frictional properties that facilitate a controlled stable movement of the moveable structure when a minimal force is applied to the moveable structure while simultaneously preventing the moveable structure from moving when a force exerted on the moveable structure is less than the minimal force.

18. The friction controlled mechanism of claim 17, wherein the moveable structure is one of a slidable door, a slidable seat, a slidable foot rest, a slidable back and neck rest, and a slidable tray and the stationary structure is one of a dashboard and a cabinet.

19. A method of assembling a friction controlled mechanism for use in a vehicle comprising:
providing a frame member;
providing a flexible member;
wrapping the flexible member around a perimeter of the frame member such that the flexible member is free to travel around the perimeter of the frame member in opposite directions; and
attaching a stop to the frame member.

20. The method of claim 19, wherein the flexible member has frictional properties that facilitate a controlled stable movement of a moveable structure in relation to a stationary structure of the cabinet assembly when a minimal force is applied to the moveable structure while simultaneously preventing the moveable structure from moving when a force exerted on the moveable structure is less than the minimal force.
